(19) United States
(12) Patent Application Publication
(10) Pub. No.: US 2006/0047602 A1
(43) Pub. Date: Mar. 2, 2006

(54) Buffering scheme for storage of broadcast content

(76) Inventors: James R. Grace, Royal Oak, MI (US); Robert M. Riley JR., Albuquerque, NM (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/017,368

(22) Filed: Dec. 20, 2004

Related U.S. Application Data
(60) Provisional application No. 60/606,198, filed on Aug. 31, 2004.

(51) Int. Cl. G06F 17/60

(52) U.S. Cl. 705/52

(57) ABSTRACT

Methods and apparatus are provided for allowing an occupant to store and/or purchase broadcasted media content in a vehicle. The method includes receiving and processing the media content from the broadcast source, temporarily storing the media content on a short-term memory storage disposed within the vehicle, while the media content is being received by a receiver in the vehicle, in response to a user input, causing a transmitter in the vehicle to transmit a purchase signal to a telematics system, and receiving a key to the media content to thereby cause the storage device to store the media content onto a long-term memory storage within the vehicle.

### CROSS-REFERENCES TO RELATED APPLICATIONS

This application claims the benefit of U.S. Provisional Application No. 60/606,198 filed Aug. 31, 2004.

### TECHNICAL FIELD

The present invention generally relates to storage of media content in a motor vehicle, and more particularly relates to a system for purchasing and storing media content on a hard disk drive in a motor vehicle.

### BACKGROUND

Vehicle operators tend to spend a significant amount of time in their vehicles particularly when commuting from a home to a workplace, running errands, conducting business, vacationing, or for many other reasons. This time is significant enough that many vehicle operators (“occupants”) utilize systems such as compact disc (CD) players, cassette tape players, radios, and satellite radios for information and entertainment (“Infotainment”) in their vehicles.

At times, media content, such as audio content broadcasted by a radio or satellite radio, may appeal to the occupant. The occupant may want to store the broadcasted media content in his/her vehicle for playback at a later time. Typically, however, vehicles are not equipped with devices on which to store such content. Additionally, the occupant may wish to purchase a copy of media content. However, the occupant may not be able to identify the broadcasted media content and may need to perform additional research to identify the media content. Alternatively, the occupant may fail to remember the particular information relating to the desired media content. Subsequently, the occupant may not make an effort to purchase the media content.

Accordingly, it is desirable to provide a system for use within a vehicle that allows an occupant to store and/or purchase media content while in the vehicle. In addition, it is desirable to provide a means by which to temporarily store the media content until the occupant submits a storage or purchase request. Moreover, it is desirable to provide a hard disk drive for a vehicle on which the media content may be permanently stored, after the media content is stored. Finally, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, a system, methods, and apparatus are provided for.

In one exemplary embodiment, a method includes receiving the media content from a broadcast source, buffering the media content, while the media content is being received, and copying the buffered media content to a storage device.

In another exemplary embodiment, a media system is provided that provides an option for a user to purchase media content while in a vehicle. The system includes a receiver, storage, device, transmitter, and a controller. The receiver is configured to receive the media content. The storage device has permanent memory storage and short-term memory storage disposed within the vehicle. The storage device is configured to permanently and temporarily store the media content in the permanent and short-term memory storage, respectively. The transmitter is coupled to the storage device and configured to transmit signals to a telematics system. The controller configured to receive and process the media content from a media broadcast, temporarily store the media content on the short-term memory storage, while the media content is being received, in response to a user input, cause the transmitter to transmit a purchase signal to the telematics system, and receive a key to the media content to thereby cause the storage device to permanently store the media content onto the permanent memory storage within the vehicle

### BRIEF DESCRIPTION OF THE DRAWINGS

The present invention will hereinafter be described in conjunction with the following drawing figures, wherein like numerals denote like elements, and

FIG. 1 is a block diagram of an exemplary media system that may be implemented into a vehicle;

FIG. 2 is a block diagram of an exemplary media purchase system that may be used to implement the media system depicted in FIG. 1; and

FIG. 3 is a flow chart of an exemplary method of using the media system depicted in FIG. 1 and media purchase system depicted in FIG. 2.

### DETAILED DESCRIPTION

The following detailed description of the invention is merely exemplary in nature and is not intended to limit the invention or the application and uses of the invention. Furthermore, there is no intention to be bound by any theory presented in the preceding background, brief summary, or the following detailed description. Moreover, although the invention is described herein as being applied to media content, it will be appreciated by those with skill in the art that the invention may be implemented for any type of media content, including but not limited to, audio and/or visual content.

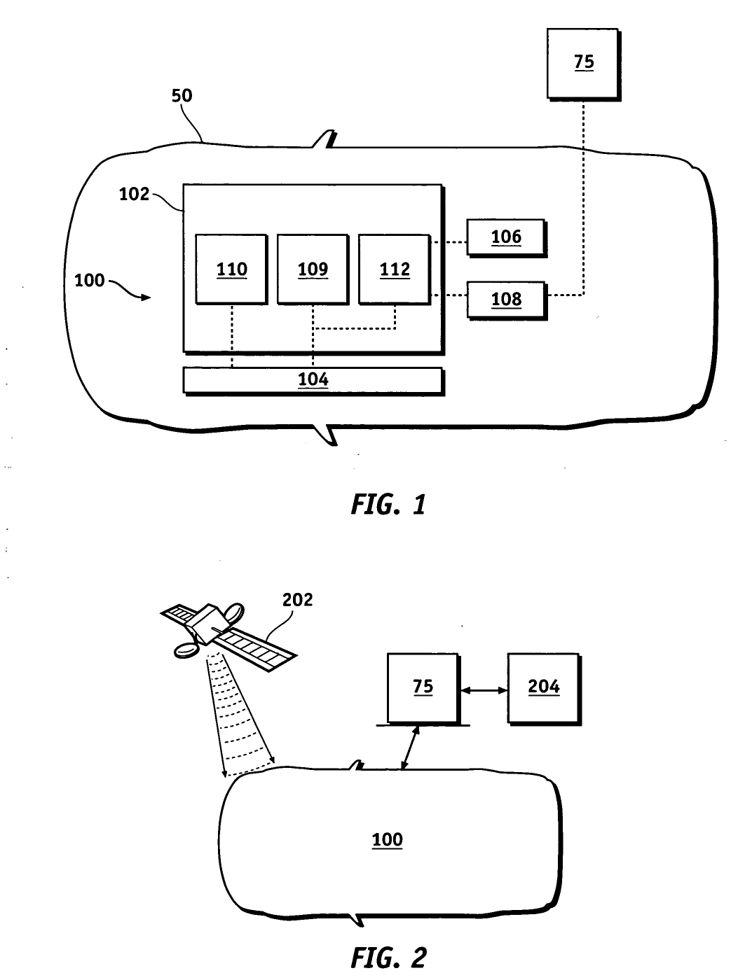

FIG. 1 provides an exemplary media system 100 that is in communication with a telematics system 75. The media system 100 is positioned, placed, situated, or otherwise located within a vehicle 50 and includes at least a radio head unit 102, a short-term memory storage 104, a user interface 106, and a wireless transceiver 108. The media system 100 allows a user to store media content in the vehicle 50.

The radio head unit 102 is wired to an electrical infrastructure (not shown) of the vehicle 50 and includes at least one storage device 109, a receiver 110, and a controller 112. The storage device 109 is any device capable of long-term memory storage of a variety of data including, but not limited to, multimedia files, such as audio files, and a variety of status and diagnostic information from the various systems and subsystems of the vehicle 50, such as ABS status information. Suitable storage devices include, but are not limited to, hard disk drives, flash memory storage and random access memory (RAM), however, a variety of other types of storage devices may also be used that have read/write operations.

The receiver 110 receives media content from a broadcast source 202 (discussed below) and can be any one of a number of conventional receivers typically used to receive media content.

The media content may be broadcasted in any one of numerous types of formats, such as in digital or analog broadcast, or any other known format. Preferably, the media content is divided into a one or more media tracks. Each media track may represent a marketable media unit such as a single song, soundbyte, audio book or other media that a listener may want to purchase and that has a beginning and an end. Alternatively, the media track may include multiple media units which a media content vendor may desire to sell to a listener.

Each media track may have identifier data associated therewith that may be simultaneously streamed to the vehicle 50 while the media track is broadcasted, e.g. via satellite digital audio radio services, terrestrial digital audio broadcast, FM RDS, and digital television and the like. For instance, the broadcasted data may provide text messages that may identify the title of the broadcasted media track, or other program related data.

Media content may be formatted into an encrypted digitized signal to prevent non-subscribers from receiving the media content. In such case, the receiver 110 suitably includes a chipset embedded therein that is configured to decrypt and process the encrypted digitized signal into a high quality broadcast. Moreover, the media content may be further encrypted a protective code that may be unencrypted with a key. The key may be made available to the user once a purchase transaction is complete.

As previously mentioned, the radio head unit 102 incorporates the controller 112. The controller 112 is capable of accessing information on the radio head unit 102, directing transfer of information to/from the radio head unit 102, and communicating with various systems and/or subsystems on the vehicle 50. The controller 112 may be implemented with a microprocessor or other conventional processing device. Although the controller 112 is shown as incorporated into the radio head unit 102, the combined configuration of the controller 112 and radio head unit 102 is not critical to the media system 100.

The controller 112 may direct transfer of media content from the radio head unit 102 to the short-term memory storage 104. The radio head unit 102 and short-term memory storage 104 may communicate wirelessly, or by any one of numerous conventional fashions. Suitable short-term memory storage include, but are not limited to CD, digital video disc (DVD), read-only memory (ROM), programmable ROM types, random access memory (RAM), floppy disk, magnetic tape, flash memory, hard disk, etc.

The user interface 106 provides communication between the user and controller 112. The user interface 106 displays identifying information or program information relating to broadcasted media content. The user interface 106 further provides an option to store the media content using a rotating knob, push button, touch screen, or any other conventional configuration allowing a user to provide input into the media system 100. In one example, a list of media content is displayed including a currently broadcasting media track and one or more previously broadcasted media tracks. An indicator, such as a pointer, may be provided along a display bar that may appear on the user interface 106. The user moves the indicator between the two media tracks by rotating a knob counter-clockwise and clockwise. The user may select a desired media track for storage by depressing a button.

In one exemplary embodiment, the system is capable of allowing the occupant to purchase a copy of the media content. To facilitate this capability, the controller 112 sends a request to purchase the selected media content to the telematics system 75. The telematics system 75 may be anyone of numerous types of systems that operate remotely (external to the vehicle) and that may provide various remote services to the user. One example of a telematics system 75 includes an OnStar® satellite system, available from OnStar Corp. of Troy, Mich. The OnStar® product provides, among other things, concierge services, vehicle assistance services, remote vehicle unlocking/locking features, navigational services, and/or vehicle tracking services. In one alternate embodiment, in order to facilitate the completion of the user's purchase request, the telematics system 75 is in communication with credit services, or any other system that may be needed and that is configured to facilitate a consumer purchase available via the internet or by other transmission means.

The transceiver 108 allows the controller 112 to communicate with the telemetry system 108. The transceiver 108 may communicate with the telematics system 75 over a wireless network including, but not limited to, an IEEE 1394 network, or a cellular network to transfer information to and from the telematics system 75. The particular wireless network or transceiver is not critical to the operation of the media system 100 provided each is compatible with the other. Additionally, a variety of different conventional wireless receivers, transmitters, and transceivers may be used to transfer information between the radio head unit 102 and the telematics system 75.

Turning now to FIG. 2, an exemplary media purchase system 200 in which the media system 100 described above may be implemented is provided. The media purchase system 200 includes the media system 100, the telematics system 75, a broadcast source 202, and a broadcast service 204. As described in detail above, the media system 100 and telematics system 75 communicate with one another to allow a user to purchase media content.

Before the user can purchase the media content, however, the content is broadcasted to the vehicle 50 via the broadcast source 202. The broadcast source 202 may be any one of numerous types of systems or devices that wirelessly broadcasts media content, including, but not limited to the satellite radio systems, space vehicles, such as satellites configured to beam signals to satellite radio subscribers, or terrestrial devices, such as radio towers. No matter the particular type of broadcast source 202, it will be appreciated that the broadcast source 202 should be compatible with the vehicle receiver 108 so that the media content can be successfully broadcasted to the user.

The broadcast service 204 supplies media content to the broadcast source 202. Additionally, the broadcast service 204 communicates with the telematics system 75 to handle and complete received purchase requests. Thus, the broadcast service 204 may also be in communication with credit services, or any other system that may be needed and that is configured to facilitate a consumer purchase available via the internet or by other transmission means. In other exemplary embodiments, the broadcast service 204 sells, supplies, and/or bundles the media content into marketable packages.

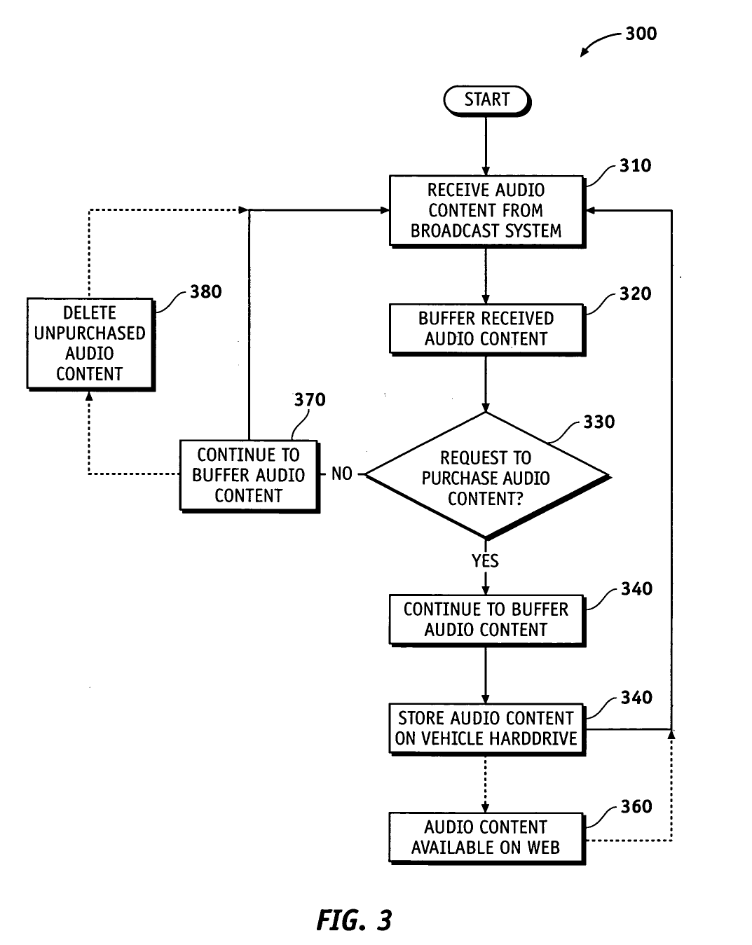

FIG. 3 is a flow chart that depicts an exemplary method of purchasing media content as it is being broadcasted. It should be understood that the parenthetical references in the following description correspond to the reference numerals associated with the flowchart blocks shown in FIG. 2. With reference to both FIGS. 1-3, first, media content is received by the media system 100 (310). In one exemplary embodiment, the vehicle 50 receives media content from the broadcast source 202 via the vehicle receiver 108. The media content may be received on at least a first or a second audio channel. If the received media content is encrypted, it is decrypted by the controller 112 and subsequently received by the user as high quality content.

Next, the media content is buffered (320). As the media content is received, it is stored on the short-term memory storage 104. It will be appreciated that the media content may be continuously received by the receiver 108 on the first audio channel, even while the user is listening to either a second audio channel or while the audio sound may be turned off. In either case, the media content may still be buffered in the short-term memory storage 104. In one exemplary embodiment, the media content is divided into individual media tracks, each having a distinct beginning and end. Each received media track is stored in the short-term memory storage 104 from its beginning to its end. In another exemplary embodiment, the media track is stored in the short-term memory storage 104, at least while a subsequent, second media track is being transmitted. In yet another exemplary embodiment, the second media track is buffered while being transmitted and while the first media track is being stored in the short-term memory storage 104. Thus, at least one complete media track is stored on the short-term memory storage 104 at all times. It will further be appreciated that more than one complete media track may be buffered.

At some point during the broadcast of a media track, the user may decide to store and/or purchase a media track. If so, the user inputs a storage/purchase request into the media system 100 (330). In one embodiment, the user selects the media track to be stored and/or purchased by appropriately operating the user interface 106. The user interface 106 transmits the request to the controller 112, which in turn sends an appropriate signal to the telematics system 75 via the transceiver 108. The telematics system 75 verifies the purchase request and then sends the verification to the broadcast service 204. In another exemplary embodiment, the telematics system 75 sends the purchase request to the broadcast service 204 and the broadcast service verifies the purchase request. The broadcast service may then perform credit services to complete the purchase request.

If the purchase request is made at a point in the middle of the media track, the media track continues to be buffered in the short-term memory storage 104 until the media track is completed (340).

After the media track is completed, it is then stored onto the vehicle radio head unit 102 (350). In one exemplary embodiment, the telematics system 75 transmits an appropriate signal to the controller 112 to cause the purchased media track to be stored on the vehicle radio head unit 102. If the media content is encrypted, the broadcast service 204 wirelessly transmits a key to the telematics system 75, which in turn transmits the key to the vehicle 50. When the key is received by the vehicle 50, the controller 112 uses the key to decode the protective code allowing the media content to be transferred from the short-term memory storage 104 to the radio head unit 102.

In another exemplary embodiment, the broadcast service 204 may choose to make the purchased media content available for download on a website (360). The user can then log on to the website and download the purchased media content to a home personal computer or other media playback device. In another exemplary embodiment, if the user submits a request to purchase a first media track at a point during the broadcast of a second media track, the telematics system 75 transmits an appropriate signal to the controller 112 to cause the first media track to be stored on the vehicle radio head unit 102 while the second media track continues to be buffered.

If no request to purchase is made, the media track continues to be buffered onto the short-term memory storage 104 until the media track is completed (370). The buffered media track is available for download to the vehicle radio head unit 102 if the user subsequently decides to purchase the media track. It will be appreciated that the number of media tracks temporarily stored on the short-term memory storage 104 may be limited to the memory capacity of the medium 104. Thus, media tracks that are not selected for purchase may be automatically deleted from the short-term memory storage 104 after a predetermined length of time or after storage capacity is reached (380).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A media system for providing an option for a user to purchase media content received from a broadcast source while the user is in a vehicle, the system comprising:
a receiver configured to receive the media content;
a storage device coupled to the receiver and disposed within the vehicle, the storage device having a long-term memory storage and a short-term memory storage;
a transmitter coupled to the storage device and configured to transmit signals to a telematics system; and
a controller configured to:
receive and process the media content from the broadcast source;
temporarily store the media content on the short-term memory storage, while the media content is being received;
in response to a user input, cause the transmitter to transmit a purchase signal to the telematics system; and
receive a key to the media content from the telematics system to thereby cause the storage device to store the media content onto the long-term memory storage within the vehicle.

2. The media system of claim 1, wherein the storage device is configured to store digital data.

3. The media system of claim 1, further comprising a user interface coupled to the controller and configured to receive the user input.

4. A method for providing an option to a user to purchase media content received from a broadcast source while the user is in a vehicle, the method comprising:
receiving and processing the media content from the broadcast source;
temporarily storing the media content on a short-term memory storage disposed within the vehicle, while the media content is being received by a receiver in the vehicle;
in response to a user input, causing a transmitter in the vehicle to transmit a purchase signal to a telematics system; and
receiving a key to the media content to thereby cause the storage device to store the media content onto a long-term memory storage within the vehicle.

5. The method of claim 4, wherein the long-term memory storage and short-term memory storage are configured to store digital data.

6. The method of claim 4, wherein the broadcast source is a satellite radio.

7. The method of claim 4, wherein the media content comprises at least a first media track having a beginning and an end.

8. The method of claim 7, wherein the user input is received before the end of the first media track.

9. The method of claim 7, wherein the user input is received after the end of the first media track. The method of claim 7, wherein the media content further includes a second media track and the method further comprises the step of maintaining the first media track in a short-term memory storage, while the second media track is being received and stored in the short-term memory storage.

10. The method of claim 4, wherein the media content comprises at least a first media track having a beginning and an end and the step of temporarily storing the media content further comprises storing the first media track on a short-term memory storage coupled to the storage device.

11. The method of claim 4, further comprising receiving a datacast identifying the media content.

13. A media system for providing an option for a user to purchase media content received from a broadcast service while the user is in a vehicle, the system comprising:
a receiver configured to receive the media content;
a storage device coupled to the receiver and disposed within the vehicle, the storage device having long-term memory storage and short-term memory storage;
a transmitter coupled to the storage device and configured to transmit signals to a telematics system; and
a controller configured to:
receive the media content from the broadcast source;
temporarily store the media content on the short-term memory storage while the media content is being received; and
copy the temporarily stored media content to the long-term memory storage, in response to a user input.

14. The media system of claim 13, wherein the storage device is configured to store digital data.

15. The media system of claim 13, further comprising a user interface coupled to the controller and configured to receive user input.

16. A method for storing media content in a vehicle, the media content received from a broadcast source, the method comprising:
receiving the media content from the broadcast source;
temporarily storing the media content on a short term memory storage while the media content is being received; and
copying the temporarily stored media content to a long-term memory storage within the vehicle in response to a user input.

17. The method of claim 16, wherein the broadcast source is a satellite radio.

18. The method of claim 16, further comprising:
in response to the user input, transmitting a purchase signal to a telematics system; and
receiving a key to the media content from a telematics system to thereby store the media content on the long-term memory storage.

19. The method of claim 16, wherein the media content comprises at least a first media track having a beginning and an end.

20. The method of claim 19, wherein the user input is received before the end of the first media track.

21. The method of claim 19, wherein the user input is received after the end of the first media track.

22. The method of claim 19, wherein the media content further includes a second media track and the method further comprises the step of maintaining the first media track in a short-term memory storage, while the second media track is being buffered.

23. The method of claim 16, wherein the media content comprises at least a first media track having a beginning and an end and the step of buffering the media content further comprises storing the first media track on a short-term memory storage coupled to the storage device.

24. The method of claim 16, wherein the media content is broadcasted on a first channel while a user is listening to a second channel.

25. The method of claim 16, further comprising receiving a datacast identifying the media content.

26. A method of facilitating sales of media content transmitted by a broadcast service to a vehicle and stored on the vehicle, the method comprising:
receiving a request to purchase the media content stored on the vehicle;
transmitting the request to purchase the media content to the broadcast service;
receiving approval from the broadcast service; and
transmitting approval to the vehicle to unlock the media content stored on the vehicle.
